(19) United States
(12) Patent Application Publication
(10) Pub. No.: US 2013/0294852 A1
(43) Pub. Date: Nov. 7, 2013

(54) COMPRESSION CUTTING TOOL

(71) Applicant: John Richard Winebrenner, Latrobe, PA (US)

(72) Inventor: John Richard Winebrenner, Latrobe, PA (US)

(73) Assignee: SECO TOOLS AB, Fagersta (SE)

(21) Appl. No.: 13/460,895

(22) Filed: May 1, 2012

(51) Int. Cl. B23C 5/10; B23P 15/34

(52) U.S. Cl. 407/54; 76/115

(57) ABSTRACT

A rotating tool includes a tool body including a first end and a second end. A plurality of first helical flutes extend from the first end of the tool body, each first helical flute of the plurality of helical flutes defining a respective first cutting edge. A plurality of second helical flutes intersect with the first helical flutes at non-zero distances from the first and the second ends of the tool body, each second helical flute of the plurality of second helical flutes defining a respective second cutting edge. The first helical flutes and the second helical flutes are of opposite hands. The first helical flutes have a first pitch and the second helical flutes have a second pitch. A plurality of chip divider recesses are formed along each first cutting edge.

### BACKGROUND AND SUMMARY

The present invention relates generally to cutting tools and, more particularly, to compression cutters.

When machining a workpiece using a cutting tool with helical cutting edges and flutes, the workpiece will have a tendency to be pulled upward due to the helix of the tool. It is desirable to reduce this tendency.

When machining materials having fibers, such as fiber reinforced composite materials, the fibers have a tendency to be pulled in a direction of the helix of the tool. Standard compression tooling tends to pull the fibers into the center of the workpiece. This promotes fiber pull out where the tool and workpiece meet. It is desirable to avoid this.

According to an aspect of the present invention, a rotating tool comprises a tool body comprising a first end and a second end, a plurality of first helical flutes extending from the first end of the tool body, each first helical flute of the plurality of helical flutes defining a respective first cutting edge, a plurality of second helical flutes intersecting with the first helical flutes at non-zero distances from the first and the second ends of the tool body, each second helical flute of the plurality of second helical flutes defining a respective second cutting edge, the first helical flutes and the second helical flutes being of opposite hands, the first helical flutes having a first pitch and the second helical flutes having a second pitch, and a plurality of chip divider recesses formed along each first cutting edge.

According to another aspect of the present invention, a rotating tool comprises a tool body comprising a first end and a second end, a plurality of first helical flutes extending from the first end of the tool body, each first helical flute of the plurality of helical flutes defining a respective first cutting edge, and a plurality of second helical flutes intersecting with the first helical flutes at non-zero distances from the first and the second ends of the tool body, each second helical flute of the plurality of second helical flutes defining a respective second cutting edge, the first helical flutes and the second helical flutes being of opposite hands, wherein the first helical flutes spiral in one of a clockwise and a counterclockwise direction when the tool is viewed from the first end toward the second end and each first cutting edge is disposed on, respectively, one of a clockwise side and a counterclockwise side of its respective first helical flute, and the first helical flutes having a first pitch and the second helical flutes having a second pitch greater than the first pitch, the second pitch being between 5°-50° larger than the first pitch.

According to yet another aspect of the present invention, a method of making a rotating tool comprises determining a depth of a hole to be formed in a workpiece by the rotating tool, and forming, in a tool body comprising a first end and a second end, a plurality of first helical flutes extending from the first end of the tool body, each first helical flute of the plurality of helical flutes defining a respective first cutting edge, and a plurality of second helical flutes intersecting with the first helical flutes, each second helical flute of the plurality of second helical flutes defining a respective second cutting edge, the first helical flutes and the second helical flutes being of opposite hands, the first helical flutes having a first pitch and the second helical flutes having a second pitch, wherein the second helical flutes and the first helical flutes intersect at a distance from the first end of the tool body determined as a function of the depth of the hole.

### BRIEF DESCRIPTION OF THE DRAWINGS

The features and advantages of the present invention are well understood by reading the following detailed description in conjunction with the drawings in which like numerals indicate similar elements and in which:

FIG. 1 is a side view of a cutting tool according to an aspect of the present invention;

FIG. 2 is a perspective view of an end of a cutting tool according to an aspect of the present invention;

FIG. 3 is a side view of the cutting tool of FIG. 2;

FIG. 4 is a cross-sectional view of portion of a cutting tool according to an aspect of the present invention taken generally along a longitudinal axis of the tool;

FIG. 5 is a cross-sectional view of portion of a cutting tool according to an aspect of the present invention taken generally perpendicular to a longitudinal axis of the tool; and

FIG. 6 is a side view of a cutting tool according to an aspect of the present invention used for forming a through hole in a workpiece.

### DETAILED DESCRIPTION

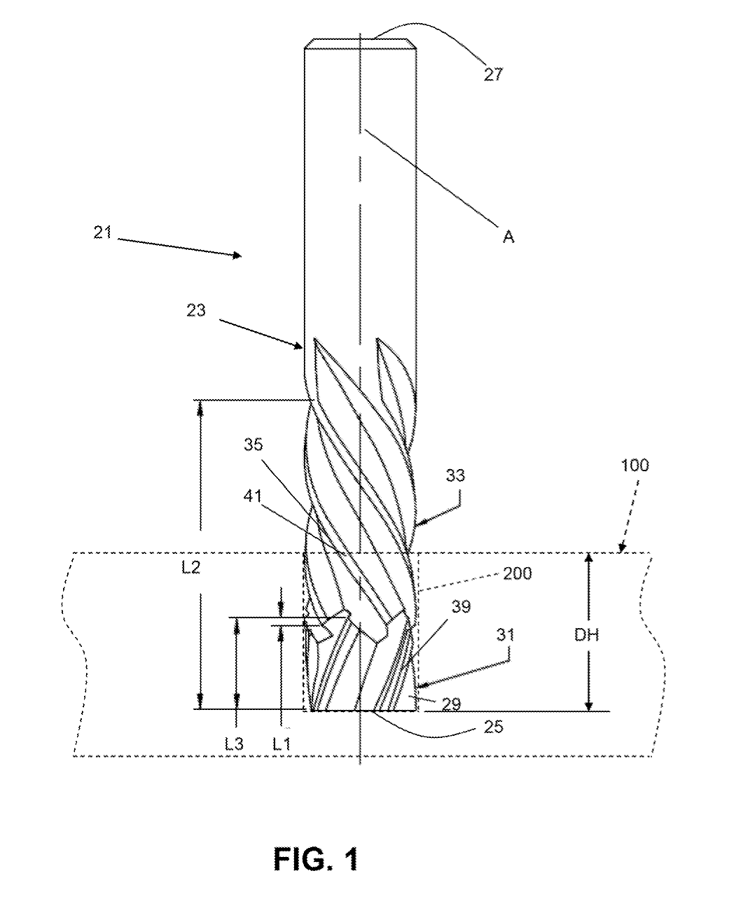

A rotating tool 21 according to an aspect of the present invention is shown in FIG. 1. The tool 21 is particularly useful as a compression cutting tool. The tool 21 comprises a tool body 23 comprising a first end 25 and a second end 27. The second end 27 typically forms part of a shank of the tool 21.

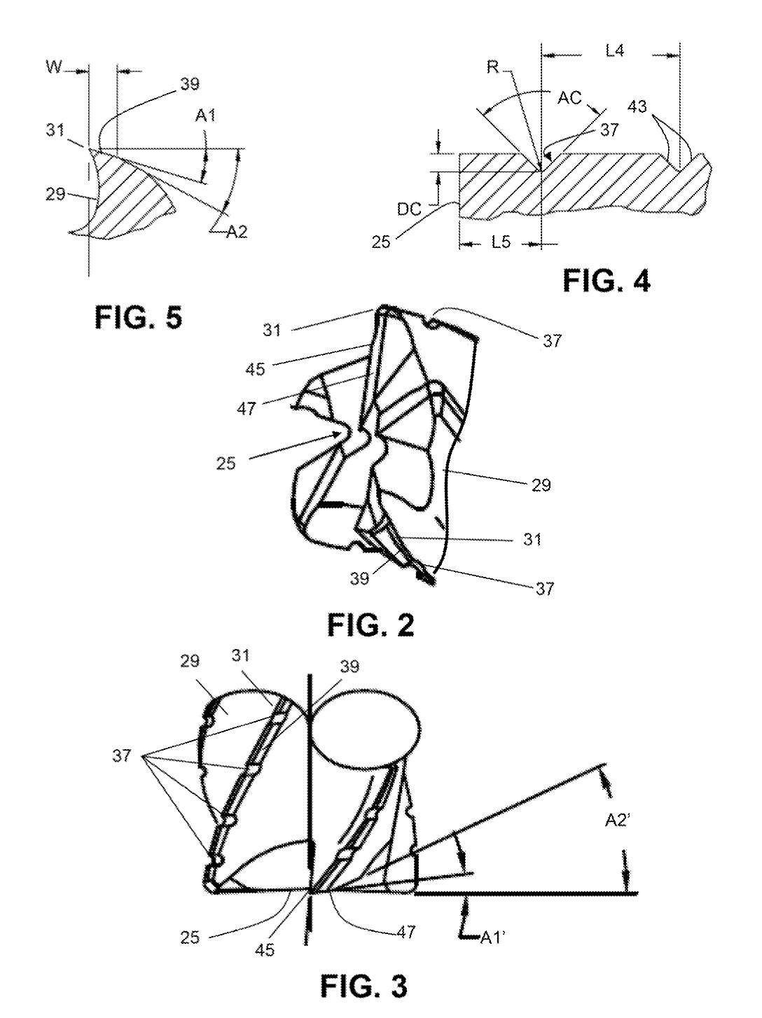

A plurality of first helical flutes 29 extend from the first end 25 of the tool body. The embodiment shown in FIG. 2 includes five flutes 29. Each first helical flute 29 of the plurality of helical flutes defines a respective first cutting edge 31.

As seen in FIG. 1, a plurality of second helical flutes 33 intersect with the first helical flutes 29 at non-zero distances from the first and the second ends 25 and 27 of the tool body 23 according to the length L1 of the first flute and the length L2 of the first and second flutes. Each second helical flute 33 of the plurality of second helical flutes defines a respective second cutting edge 35. Ordinarily, the second helical flutes 33 and the first helical flutes 29 overlap over some overlap length L3.

The first helical flutes 29 and the second helical flutes 33 are of opposite hands, i.e., when the first helical flutes turn in a clockwise direction when viewed from the first end 25 of the tool body 23 toward the second end 27, the second helical flutes turn in a counterclockwise direction, and vice versa. There is ordinarily the same number of first helical flutes 29 as the number of second helical flutes 33. If the first helical flutes 29 turn in a clockwise direction, then the first cutting edges 31 are ordinarily disposed on a clockwise side of their respective first helical flutes and, if the first helical flutes turn in a counterclockwise direction, then the first cutting edges are ordinarily disposed on a counterclockwise side of their respective first helical flutes. Likewise, if the second helical flutes 33 turn in a clockwise direction, then the second cutting edges 35 are ordinarily disposed on a clockwise side of their respective second helical flutes and, if the second helical flutes turn in a counterclockwise direction, then the second cutting edges are ordinarily disposed on a counterclockwise side of their respective second helical flutes.

The first helical flutes 29 having a first pitch and the second helical flutes 33 have a second pitch. The first and second pitches are ordinarily different and, more particularly, the first pitch is less than the second pitch. The second pitch is ordinarily between 5°-50° larger than the first pitch and, in a presently preferred embodiment, the first pitch is between 20°-29° and the second pitch is between 30°-40°. The portion of the tool 21 over which the first helical flutes 29 extend is often referred to as an “up-shear” portion, and the portion over which the second helical flutes 33 extend is often referred to as a “down-shear” portion. When the tool 21 is used to machine a workpiece 100 (seen in phantom in FIG. 1), the up-shear portion tends to draw the workpiece in a direction from the first end 25 to the second end 27 of the tool (upward in FIG. 1), while the down-shear portion tends to force the workpiece in an opposite direction from the second end toward the first end (downward in FIG. 1).

As seen in FIGS. 2-4, a plurality of chip divider recesses 37 (chip dividers) are ordinarily formed along each first cutting edge 31 and also ordinarily along each second cutting edge 35. The chip divider recesses along the second cutting edges 35 will ordinarily have the same general shape as the chip dividers along the first cutting edges 31 and the discussion of the chip dividers along the first cutting edges shall be understood to apply to chip dividers along the second cutting edges, except where otherwise indicated. The chip dividers 37 extend from the cutting edges 31 and 35 at least onto lands 39 (FIGS. 1-3, and FIG. 4) and 41 (FIGS. 1-3), respectively, adjacent the cutting edges.

As seen, for example, in FIGS. 2-4, a series of chip dividers 37 are provided along the first cutting edge 31, usually with even spacing L4 as seen in FIG. 4 between successive chip dividers. A chip divider 37 closest to the first end 25 of the tool body 23 is ordinarily spaced less than the distance L4 from the first end.

The tool 21 may have any desired number of first flutes 29 and second flutes 33, and may have different numbers of first flutes and second flutes. In a presently preferred embodiment, for a tool 21 having five first flutes 29 and five second flutes 33, a core diameter (i.e., 2× radius to bottom of flute) of 0.3500 inches (0.8890 cm) and a shank diameter (i.e., diameter of unfluted portion of tool) of 0.5000 inches (1.2700 cm), the chip divider 37 closest to the first end 25 is centered at a distance L5 of 0.0500 inches (0.1270 cm) from the first end, and each successive chip divider on the first cutting edge 31 is spaced the distance L4 at 0.1250 inches (0.3175 cm) from each preceding chip divider. The same spacing for chip dividers 37 along the second cutting edge 35 will ordinarily be maintained. A presently preferred form of the chip divider 37 is, as seen in FIG. 4, a substantially V-shaped notch or groove that may be radiused at a bottom of the groove (presently preferred radius R equal to 0.0050 inches (0.013 cm) maximum), with sides 43 of the groove being flat and together forming a right angle AC. A presently preferred depth DC of such a chip divider 37 is 0.0250 inches (0.0635 cm). In such a tool 21, a width W of the lands 39 and 41 is 0.0025 inches (0.0064 cm), and a primary relief angle A1 of the lands is 14°. A secondary relief angle A2 is 22°. It will be appreciated that chip dividers 37 having different geometries and sizes can be provided, and that chip dividers can be located more closely together or farther apart along the lengths of the cutting edges 31 and 35.

Radially extending cutting edges 45 are ordinarily provided at the first end 25 of the cutting tool 21. These cutting edges 45 are also typically associated with lands 47. In a presently preferred embodiment of the tool thus far described, the lands 47 have a width of 0.0035 inches, and form a first relief angle A1′ to a plane perpendicular to the longitudinal axis A of the tool 21 equal to 14°. A second relief angle A2′ of such a tool is 22°.

The tool 21 is typically manufactured with reference to the task to which it will be applied. As seen in FIG. 1, the tool 21 will ordinarily be used to form a hole 200 in a workpiece 100 (shown in phantom). The hole 200 may be a circular hole having substantially the same diameter as the tool 21, a groove or elongated hole, or for material removal (i.e., usually a series of overlapping grooves). The hole 200 may be a through hole or, as shown, a blind hole.

To manufacture the tool 21, a depth DH of the hole 200 to be formed in the workpiece 100 by the rotating tool is determined. The tool 21 is formed so that the second helical flutes 33 and the first helical flutes 29 intersect at a distance L1 (i.e., at least approximately the length of the first helical flutes) from the first end of the tool body determined as a function of the depth DH of the hole and of the type of hole.

If the hole 200 to be formed is a blind hole as seen in FIG. 1, the distance L1 will ordinarily be less than the depth of the hole. In this way, the region of the overlapping length L3 of the first and second flutes 29 and 33 will be disposed remote from the surface of the workpiece. The potential for delamination of the workpiece 100 can thus be minimized as fibers will tend to be sheared off at a location other than on the surface of the workpiece.

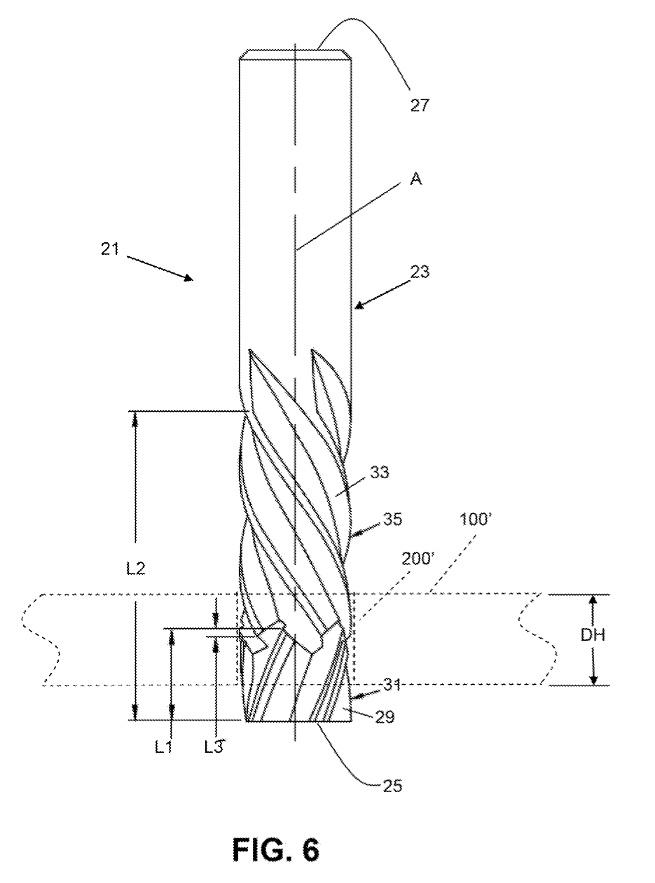

If, as seen in FIG. 6, the hole 200′ to be formed is a through hole, the distance L1 can be as great as the thickness of the workpiece 100′ so that the hole can be entirely formed before the second cutting edges 35 reach the hole, and so that the region of the overlapping length L3 of the first and second flutes 29 and 33 can be disposed substantially in the center of the workpiece when the tool 21 is at its intended depth relative to the workpiece. In this way, the potential for delamination of the workpiece can be minimized as fibers will tend to be sheared off toward the center of the hole rather than on the surface of the workpiece. The distance L1 may, however, be shorter than the length of the hole 200′, or longer, while still permitting the overlapping region L3 to be disposed remote from either surface of the workpiece.

By providing the second helical flutes 33 in a position determined relative to the depth of the hole to be formed in the workpiece, when the tool 21 has machined material to the desired depth, a tendency of the workpiece to continue climbing up the tool is resisted by the second flutes/cutting edges that turn in an opposite direction to the direction of the first flutes/cutting edges. Moreover, by providing the second flutes/cutting edges with a larger pitch than the first flutes/cutting edges, a greater force resisting the tendency of the workpiece 100 to continue climbing up the tool can be provided by second flutes/cutting than by the first flutes/cutting edges. In this way, the potential for harmonics to develop in the workpiece can be minimized.

By providing chip dividers 37 along the first cutting edge 31 and, ordinarily, the second cutting edge 35, fibers in the workpiece are allowed to relax back into their original location as opposed to being constantly pulled into the center of the intersection point of the tool. This tends to reduce problems of fiber pull out. Fibers can be cleanly sheared off throughout the entire surface of the part.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A rotating tool, comprising:
a tool body comprising a first end and a second end;
a plurality of first helical flutes extending from the first end of the tool body, each first helical flute of the plurality of helical flutes defining a respective first cutting edge;
a plurality of second helical flutes intersecting with the first helical flutes at non-zero distances from the first and the second ends of the tool body, each second helical flute of the plurality of second helical flutes defining a respective second cutting edge, the first helical flutes and the second helical flutes being of opposite hands, the first helical flutes having a first pitch and the second helical flutes having a second pitch; and
a plurality of chip divider recesses formed along each first cutting edge.

2. The rotating tool as set forth in claim 1, comprising a plurality of chip divider recesses formed along each second cutting edge.

3. The rotating tool as set forth in claim 1, wherein the first pitch is less than the second pitch.

4. The rotating tool as set forth in claim 1, wherein the first pitch is between 20°-29° and the second pitch is between 30°-40°.

5. The rotating tool as set forth in claim 1, wherein the second pitch is between 5°-50° larger than the first pitch.

6. The rotating tool as set forth in claim 1, wherein the first helical flutes spiral in one of a clockwise direction when the tool is viewed from the first end toward the second end.

7. The rotating tool as set forth in claim 7, wherein each first cutting edge is disposed on a clockwise side of its respective first helical flute.

8. A rotating tool, comprising:
a tool body comprising a first end and a second end;
a plurality of first helical flutes extending from the first end of the tool body, each first helical flute of the plurality of helical flutes defining a respective first cutting edge; and
a plurality of second helical flutes intersecting with the first helical flutes at non-zero distances from the first and the second ends of the tool body, each second helical flute of the plurality of second helical flutes defining a respective second cutting edge, the first helical flutes and the second helical flutes being of opposite hands,
wherein the first helical flutes spiral in one of a clockwise and a counterclockwise direction when the tool is viewed from the first end toward the second end and each first cutting edge is disposed on, respectively, one of a clockwise side and a counterclockwise side of its respective first helical flute, and the first helical flutes having a first pitch and the second helical flutes having a second pitch greater than the first pitch, the second pitch being between 5°-50° larger than the first pitch.

9. The rotating tool as set forth in claim 8, comprising a plurality of chip divider recesses formed along each first cutting edge.

10. The rotating tool as set forth in claim 8, comprising a plurality of chip divider recesses formed along each second cutting edge.

11. The rotating tool as set forth in claim 8, wherein the first pitch is between 20°-29° and the second pitch is between 30°-40°.

12. A method of making a rotating tool, comprising:
determining a depth of a hole to be formed in a workpiece by the rotating tool;
forming, in a tool body comprising a first end and a second end, a plurality of first helical flutes extending from the first end of the tool body, each first helical flute of the plurality of helical flutes defining a respective first cutting edge, and a plurality of second helical flutes intersecting with the first helical flutes, each second helical flute of the plurality of second helical flutes defining a respective second cutting edge, the first helical flutes and the second helical flutes being of opposite hands, the first helical flutes having a first pitch and the second helical flutes having a second pitch, wherein the second helical flutes and the first helical flutes intersect at a distance from the first end of the tool body determined as a function of the depth of the hole.

13. The method as set forth in claim 12, comprising providing a plurality of chip divider recesses along each first cutting edge.

14. The method as set forth in claim 13, comprising providing a plurality of chip divider recesses along each second cutting edge.

15. The method as set forth in claim 12, wherein the first pitch is less than the second pitch.

16. The method as set forth in claim 12, wherein the first pitch is between 20°-29° and the second pitch is between 30°-40°.

17. The method as set forth in claim 12, wherein the second pitch is between 5°-50° larger than the first pitch.

18. The method as set forth in claim 12, wherein the second helical flutes and the first helical flutes intersect at a distance from the first end of the tool body less than the depth of the hole.

19. The method as set forth in claim 12, wherein the second helical flutes and the first helical flutes intersect at a distance from the first end of the tool body equal to or greater than the depth of the hole.
